(19) United States
(12) Patent Application Publication
(10) Pub. No.: US 2009/0319447 A1
(43) Pub. Date: Dec. 24, 2009

(54) SELF-CONTAINED RECYCLING COLLECTION SYSTEM

(76) Inventor: TIMOTHY SHEEHAN, Wenham, MA (US)

Correspondence Address: HOLLAND & KNIGHT LLP, 10 ST. JAMES AVENUE, BOSTON, MA, 02116-3889, US

(21) Appl. No.: 12/488,981

(22) Filed: Jun. 22, 2009

Related U.S. Application Data
(60) Provisional application No. 61/074,398, filed on Jun. 20, 2008.

(51) Int. Cl. G06Q 90/00

(52) U.S. Cl. 705/500

(57) ABSTRACT

A self-contained recycling collection system includes a product reception assembly configured to receive a recyclable product from a user. A remuneration assembly is configured to provide remuneration to the user upon receiving the recyclable product. A machine-emptiable storage assembly is configured to receive the recyclable product.

### RELATED APPLICATION

This application claims the benefit of U.S. Ser. No. 61/074,398, filed on 20 Jun. 2008, the entire contents of which are herein incorporated by reference in its entirety.

### TECHNICAL FIELD

This disclosure relates to collection systems and, more particularly, to self-contained recycling collection systems.

### BACKGROUND

Various types of materials may be recycled. Examples of such recyclable materials include steel, aluminum, plastic, paper, and glass. Numerous communities have initiated recycling programs in which people sort their recyclable materials and leave them outside for curbside pickup by municipal recyclers.

Additionally, systems have been developed that allow consumers to profit for their recycling endeavors. For example, people may collect aluminum cans and return them to a recycling center for payment (i.e., based upon the weight of the aluminum recycled). Additionally, bottles often have deposits that a consumer can claim upon returning the bottle to a redemption center. Further, automated systems have been employed that e.g., allow users to return aluminum cans for cash/credit. Unfortunately, such automated systems are often located indoors and require that they be manually emptied by operators collecting the aluminum cans.

### SUMMARY OF DISCLOSURE

In a first implementation, a self-contained recycling collection system includes a product reception assembly configured to receive a recyclable product from a user. A remuneration assembly is configured to provide remuneration to the user upon receiving the recyclable product. A machine-emptiable storage assembly is configured to receive the recyclable product.

One or more of the following features may be included. The recyclable product may be a recyclable bottle. The recyclable product may be a recyclable can. A crushing assembly may be configured to reduce the volume of the recyclable product. The crushing assembly may be a manually-powered crushing assembly. The crushing assembly may be an electrically-powered crushing assembly.

A power source may be configured to power at least a portion of the self-contained recycling collection system. The power source may include a battery-based power source. The power source may include a solar-based power source. The power source may include an AC-powered utility-based power source.

The machine-emptiable storage assembly may include a dumpster assembly. The machine-emptiable storage assembly may be configured to be emptied by a recycling truck.

In another implementation, a self-contained recycling collection system includes a product reception assembly configured to receive a recyclable can from a user. A remuneration assembly is configured to provide remuneration to the user upon receiving the recyclable can. A crushing assembly is configured to reduce the volume of the recyclable product. A machine-emptiable storage assembly is configured to receive the recyclable product.

One or more of the following features may be included. The crushing assembly may be a manually-powered crushing assembly. The crushing assembly may be an electrically-powered crushing assembly.

A power source may be configured to power at least a portion of the self-contained recycling collection system. The power source may include a battery-based power source. The power source may include a solar-based power source. The power source may include an AC-powered utility-based power source.

In another implementation, a self-contained recycling collection system includes a product reception assembly configured to receive a recyclable can from a user. A remuneration assembly is configured to provide remuneration to the user upon receiving the recyclable product. A crushing assembly is configured to reduce the volume of the recyclable product. A machine-emptiable dumpster assembly is configured to receive the recyclable product and be emptied by a recycling truck.

One or more of the following features may be included. The recyclable product may be a recyclable bottle. The recyclable product may be a recyclable can. The crushing assembly may be a manually-powered crushing assembly. The crushing assembly may be an electrically-powered crushing assembly. A power source may be configured to power at least a portion of the self-contained recycling collection system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a self-contained recycling collection system;

FIG. 2 is an isometric view of a first embodiment of the self-contained recycling collection system of FIG. 1; and

FIG. 3 is an isometric view of a second embodiment of the self-contained recycling collection system of FIG. 1.

Like reference symbols in the various drawings indicate like elements.

### DETAILED DESCRIPTION OF THE PREFERRED EMBODIMENTS

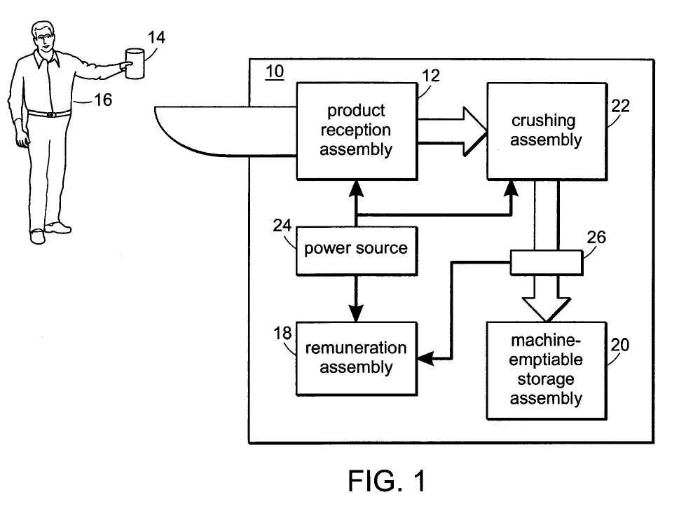

Referring to FIG. 1, there is shown self-contained recycling collection system 10 that may include product reception assembly 12 that may be configured to receive recyclable product 14 from user 16. Examples of recyclable product 14 may include but are not limited to recyclable bottles and recyclable cans.

Remuneration assembly 18 may be configured to provide remuneration (e.g., cash, store credits, download credits) to user 16 in response to receiving recyclable product 14 from user 16. Machine-emptiable storage assembly 20 may be configured to receive recyclable product 14. Crushing assembly 22 may be configured to reduce the volume of recyclable product 14 prior to being provided to machine-emptiable storage assembly 20. Power source 24 may be configured to power at least a portion of self-contained recycling collection system 10. Sensor assembly 26 may be configured to confirm the placement of recyclable product 14 into machine-emptiable storage assembly 20.

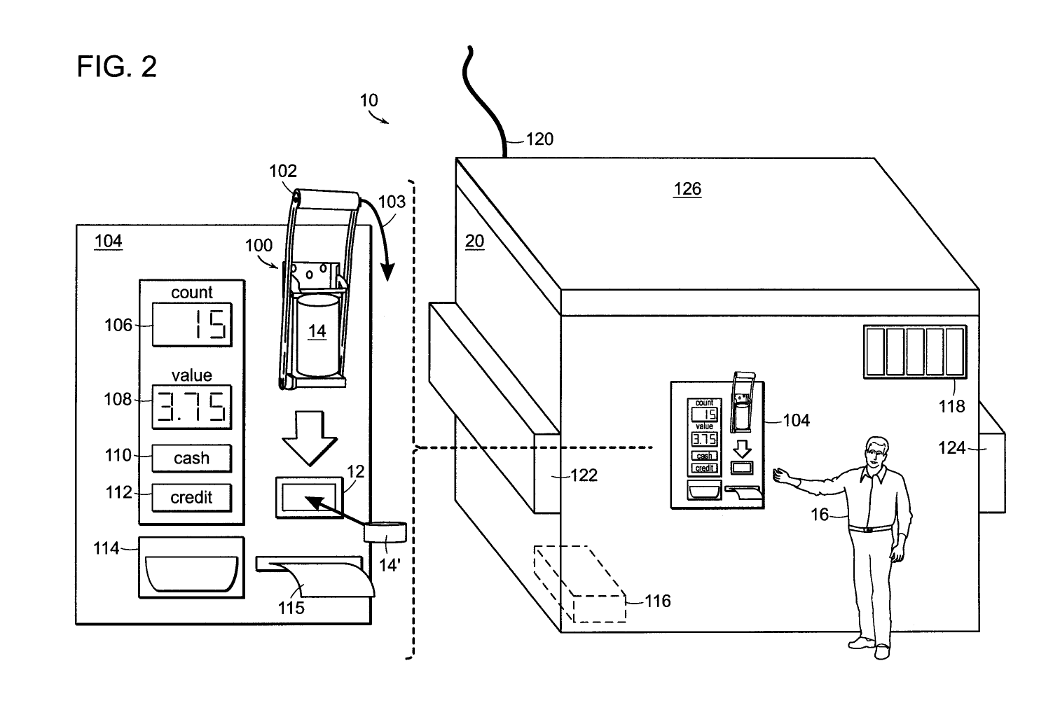

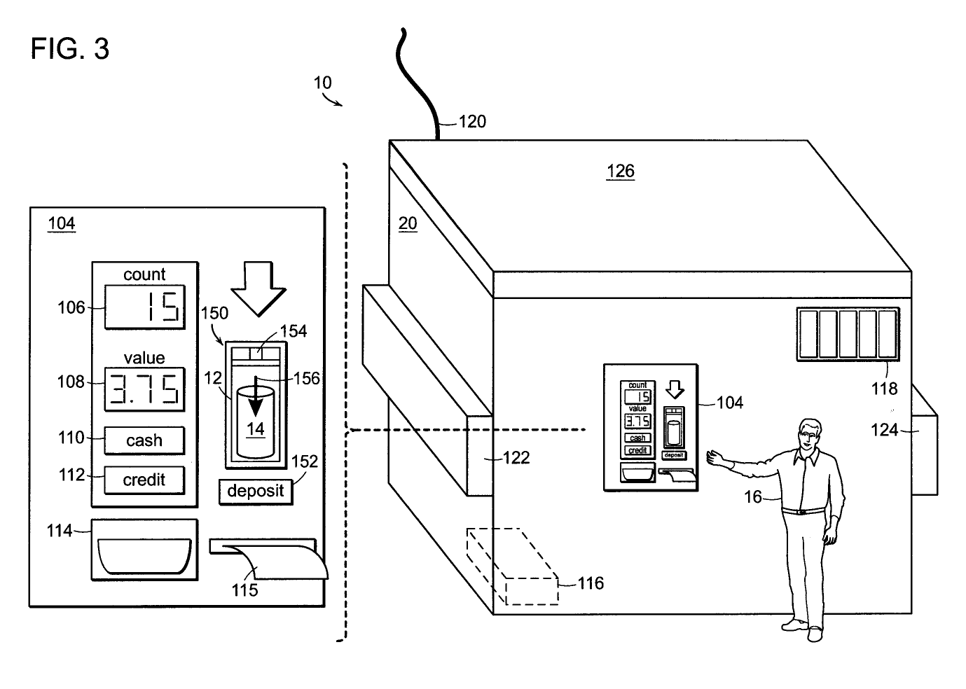

Referring also to FIGS. 2 & 3, crushing assembly 22 may be configured as manually-powered crushing assembly 100 (as shown in FIG. 2) or electrically-powered crushing assembly 150 (as shown in FIG. 3).

When self-contained recycling collection system 10 includes manually-powered crushing assembly 100, self-contained recycling collection system 10 may consume less power than when self-contained recycling collection system 10 includes electrically-powered crushing assembly 150. Specifically, through the use of lever assembly 102 (manually displaceable in the direction of arrow 103), user 16 may crush (i.e., compress) recyclable product 14 to reduce the volume of recyclable product 14 prior to being provided to machine-emptiable storage assembly 20. For example, user 16 may place recyclable product 14 into manually-powered crushing assembly 100. User 16 may then manually displace lever 102 in the direction of arrow 103, resulting in reduced volume recyclable product 14′. User 16 may then place reduced volume recyclable product 14′ into product reception assembly 12 which may be configured to direct reduced volume recyclable product 14′ into machine-emptiable storage assembly 20. Once placed within product reception assembly 12, reduced volume recyclable product 14′ may be sensed by sensor assembly 26. Examples of sensor assembly 26 may include but are not limited to a switch assembly that is manually tripped by the passage of reduced volume recyclable product 14′. Alternatively, an optical sensor may be used in which the passage of reduced volume recyclable product 14′ interrupts an optical beam.

The output of sensor assembly 26 may be provided to remuneration assembly 18. Remuneration assembly 18 may include control panel 104 that is configured to display pertinent information and allow user 16 to operate self-contained recycling collection system 10. For example, control panel 104 may include counter display 106 that indicates the amount of recyclable products that were deposited into self-contained recycling collection system 10. Control panel 104 may further include refund display 108 that is indicative of the remuneration owed to user 16. For example, remuneration assembly 18 may allow the owner/operator (not shown) of self-contained recycling collection system 10 to define a price to be refunded per recyclable product received by product reception assembly 12. Assume for illustrative purposes that the owner/operator of self-contained recycling collection system 10 configures self-contained recycling collection system 10 to provide a refund of $0.25 per recyclable product received. Accordingly, each time that counter display 106 is incremented (to indicate receipt of a recyclable product as detected by sensor assembly 26), refund display 108 is incremented $0.25. For illustrative purposes, assume that user 16 deposited fifteen recyclable products into self-contained recycling collection system 10. Therefore, counter display 106 of control panel 104 may indicate “15” and refund display 108 of counter display 106 may indicate $3.75.

As stated above, remuneration assembly 18 may be configured to provide remuneration to user 16 (in the form of e.g., cash, store credits, download credits) in response to receiving one or more recyclable products (e.g., recyclable product 14) from user 16. Accordingly, control panel 104 may include one or more button assemblies (e.g., button assemblies 110, 112) that may allow user 16 to select their remuneration type. For example, if user 16 is interested in obtaining cash, user 16 may select “cash” button 110 and self-contained recycling collection system 10 may dispense $3.75 into cash tray 114. Alternatively, if user 16 is interested in obtaining a store credit, user 16 may select “credit” button 112 and self-contained recycling collection system 10 may print e.g., a $3.75 credit slip 115 for use within a store. Additionally/alternatively, self-contained recycling collection system 10 may be configured to provide download credits, refund display 108 of control panel 104 may be configured in indicate the refund amount in download credits (e.g., song download credits on Apple iTunes™ or RealNetworks Rhapsody™

When self-contained recycling collection system 10 includes electrically-powered crushing assembly 150, self-contained recycling collection system 10 may consume more power than when self-contained recycling collection system 10 includes manually-powered crushing assembly 100. Through the use of electrically-powered crushing assembly 150, user 16 may crush (i.e., compress) recyclable product 14 to reduce the volume of recyclable product 14 prior to being provided to machine-emptiable storage assembly 20. For example, user 16 may place recyclable product 14 into product reception assembly 12. User 16 may then select “deposit” button 152. Self-contained recycling collection system 10 may then e.g., move ram 154 of electrically-powered crushing assembly 150 downward in the direction of arrow 156, resulting in recyclable product 14 being reduced in volume (resulting in reduced volume recyclable product 14′), which may be provided to machine-emptiable storage assembly 20. As discussed above, the reduced volume recyclable product 14′ may be sensed by sensor assembly 26. The output of sensor assembly 26 may be provided to remuneration assembly 18 that may include control panel 104 that is configured in the manner discussed above.

As discussed above, self-contained recycling collection system 10 may include power source 24 that may be configured to power at least a portion of self-contained recycling collection system 10. Examples of power source 24 may include battery-based power source 116, solar-based power source 118, AC-powered utility-based power source 120, or any combination thereof. For example, solar-based power source 118 may be used to charge battery-based power source 116.

As discussed above, when self-contained recycling collection system 10 includes electrically-powered crushing assembly 150, self-contained recycling collection system 10 may consume more power than when self-contained recycling collection system 10 includes manually-powered crushing assembly 100. Accordingly, depending on the amount of power consumed by electrically-powered crushing assembly 150, the use of electrically-powered crushing assembly 150 may require the use of AC-powered utility-based power source 120 to provide the wattage required to operate electrically-powered crushing assembly 150.

The machine-emptiable storage assembly 20 may be a dumpster assembly configured to be emptied by a recycling truck (not shown). For example, machine-emptiable storage assembly 20 may include a plurality of bracket assemblies (e.g., bracket assemblies 122, 124) that are configured to e.g., releasably engage a pair of lifting forks (not shown) operable on a recycling truck. Accordingly, in a manner similar to that of a traditional dumpster-type trash container, self-contained recycling collection system 10 may be easily emptied into a standard recycling truck, without requiring the driver of the recycling truck to get out of the vehicle.

In order to reduce the possibility of theft, self-contained recycling collection system 10 may include lid assembly 126 to reduce the chances of unauthorized access to the contents of machine-emptiable storage assembly 20. For example, lid assembly 126 may be configured to only be released (i.e., openable) when self-contained recycling collection system 10 is inverted.

When configured to be powered by AC-powered utility-based power source 120, a recoil assembly (not shown) may be utilized to allow self-contained recycling collection system 10 to be emptied (via the above-described recycling truck) without causing damage to AC-powered utility-based power source 120. For example, one or more cables included within AC-powered utility-based power source 120 may be coiled around a spring-biased reel (not shown). Therefore, when self-contained recycling collection system 10 is moved (e.g., inverted) during the process of emptying machine-emptiable storage assembly 20 into the above-described recycling truck, the above-described spring-biased reel will allow for the uncoiling the one or more cables included within AC-powered utility-based power source 120, thus preventing damage to AC-powered utility-based power source 120.

While the system is described above as providing a refund in the form of cash, store credits or download credits, this is for illustrative purposes only and is not intended to be a limitation of this disclosure, as other configurations are possible and are considered to be within the scope of this disclosure. For example, self-contained recycling collection system 10 may be configured to provide video game credits for an arcade.

While FIGS. 1 & 3 show crushing assembly 22 being positioned downstream from product reception assembly 12, this is for illustrative purposes only and is not intended to be a limitation of this disclosure, as other configurations are possible. For example, in the embodiment in which manually-powered crushing assembly 100 is utilized (See FIG. 2), manually-powered crushing assembly 100 may be positioned prior to product reception assembly 12, as user 16 crushes (i.e., compresses) recyclable product 14 prior to reduced volume recyclable product 14′ being placed into product reception assembly 12.

While the system is described above as including crushing assembly 22, this is for illustrative purposes only and is not intended to be a limitation of this disclosure, as other configurations are possible and are considered to be within the scope of this disclosure. For example, if a reduction in volume is not necessary, crushing assembly 22 may be omitted and the recyclable products may be placed within machine-emptiable storage assembly 20 in an unmodified (i.e., non-crushed) form.

If self-contained recycling collection system 10 is configured to collect aluminum cans, sensor assembly 26 may include one or more magnet assemblies (not shown) for preventing the introduction of steel cans into machine-emptiable storage assembly 20.

A number of implementations have been described. Nevertheless, it will be understood that various modifications may be made. Accordingly, other implementations are within the scope of the following claims.

What is claimed is:

1. A self-contained recycling collection system comprising:
a product reception assembly configured to receive a recyclable product from a user;
a remuneration assembly configured to provide remuneration to the user upon receiving the recyclable product; and
a machine-emptiable storage assembly configured to receive the recyclable product.

2. The self-contained recycling collection system of claim 1 wherein the recyclable product is a recyclable bottle.

3. The self-contained recycling collection system of claim 1 wherein the recyclable product is a recyclable can.

4. The self-contained recycling collection system of claim 1 further comprising:
a crushing assembly configured to reduce the volume of the recyclable product.

5. The self-contained recycling collection system of claim 1 wherein the crushing assembly is a manually-powered crushing assembly.

6. The self-contained recycling collection system of claim 1 wherein the crushing assembly is an electrically-powered crushing assembly.

7. The self-contained recycling collection system of claim 1 further comprising:
a power source configured to power at least a portion of the self-contained recycling collection system.

8. The self-contained recycling collection system of claim 7 wherein the power source includes a battery-based power source.

9. The self-contained recycling collection system of claim 7 wherein the power source includes a solar-based power source.

10. The self-contained recycling collection system of claim 7 wherein the power source includes an AC-powered utility-based power source.

11. The self-contained recycling collection system of claim 7 wherein the machine-emptiable storage assembly includes a dumpster assembly.

12. The self-contained recycling collection system of claim 7 wherein the machine-emptiable storage assembly is configured to be emptied by a recycling truck.

13. A self-contained recycling collection system comprising:
a product reception assembly configured to receive a recyclable can from a user;
a remuneration assembly configured to provide remuneration to the user upon receiving the recyclable can;
a crushing assembly configured to reduce the volume of the recyclable product; and
a machine-emptiable storage assembly configured to receive the recyclable product.

14. The self-contained recycling collection system of claim 13 wherein the crushing assembly is a manually-powered crushing assembly.

15. The self-contained recycling collection system of claim 13 wherein the crushing assembly is an electrically-powered crushing assembly.

16. The self-contained recycling collection system of claim 13 further comprising:
a power source configured to power at least a portion of the self-contained recycling collection system.

17. The self-contained recycling collection system of claim 16 wherein the power source includes a battery-based power source.

18. The self-contained recycling collection system of claim 16 wherein the power source includes a solar-based power source.

19. The self-contained recycling collection system of claim 16 wherein the power source includes an AC-powered utility-based power source.

20. A self-contained recycling collection system comprising:
a product reception assembly configured to receive a recyclable can from a user;
a remuneration assembly configured to provide remuneration to the user upon receiving the recyclable product;
a crushing assembly configured to reduce the volume of the recyclable product; and
a machine-emptiable dumpster assembly configured to receive the recyclable product and be emptied by a recycling truck.

21. The self-contained recycling collection system of claim 20 wherein the recyclable product is a recyclable bottle.

22. The self-contained recycling collection system of claim 20 wherein the recyclable product is a recyclable can.

23. The self-contained recycling collection system of claim 20 wherein the crushing assembly is a manually-powered crushing assembly.

24. The self-contained recycling collection system of claim 20 wherein the crushing assembly is an electrically-powered crushing assembly.

25. The self-contained recycling collection system of claim 20 further comprising:
a power source configured to power at least a portion of the self-contained recycling collection system.
